(19) United States
(12) Patent Application Publication
(10) Pub. No.: US 2012/0154096 A1
(43) Pub. Date: Jun. 21, 2012

(54) Transformer

(75) Inventor: Olov Haapalahti, Solna (SE)

(73) Assignee: TELEFONAKTIEBOLAGET LM ERICSSON (PUBL), Stockholm (SE)

(21) Appl. No.: 13/391,863

(22) PCT Filed: Aug. 27, 2009
(86) PCT No.: PCT/SE09/50966

§ 371 Date: Feb. 23, 2012

(51) Int. Cl. H01F 19/00

(52) U.S. Cl. 336/200

(57) ABSTRACT

The invention discloses an RF ASIC, (100), which comprises first (110) and second (130) plane conductors arranged parallel to each other with an isolating material (120) of a certain thickness (d) between them, and a ground plane (150) arranged in parallel to said conductors and at a certain distance (h) from the nearest conductor. Each conductor (110, 130) is shaped as a rectangle with a width (W) and a length (L) such that the length exceeds the width, so that each conductor has opposing short sides and opposing long sides. Each conductor exhibits a connector (1, 2, 3, 4) at each of its short sides, and the ASIC can be used as a transformer by using the connectors (1, 2) on one opposing short side as input ports to the transformer, and the connectors (3, 4) on the other opposing short side as output ports.

### TECHNICAL FIELD

The present invention discloses an improved transformer.

### BACKGROUND

So called stacking of certain kinds of high power transistors requires a transformer at the input of the transistors, with the transformer not being referenced to ground since the source/emitter on these transistors “floats” with respect to AC ground.

Examples of such transistors are high power transistors which are based on such technologies as High Electron Mobility Transistors, HEMT, Lateral Diffusion Metal Oxide Semiconductors, LDMOS, as well as bipolar technologies used in power amplifier designs at radio frequencies provide n-channel and n-p-n channel devices, in which a gate/base input drive signal is referenced to a lower voltage potential at the source/emitter.

### SUMMARY

It is a purpose of the present invention to provide a transformer which can be used in the manner described above, i.e. one which will be suitable when, for example, stacking high power transistors.

Such a transformer is offered by the present invention in that it discloses a Radio Frequency Application Specific Integrated Circuit, an RF ASIC, which comprises a first and a second plane conductor arranged parallel to each other, with an isolating material of a certain thickness between them.

The transformer of the invention also comprises a ground plane arranged in parallel to the conductors at a certain distance from the nearest conductor.

Each of the conductors is shaped as a rectangle, with a width and a length such that the length exceeds the width, so that each conductor has opposing short sides and opposing long sides.

According to the invention, each conductor exhibits a connector at each of its short sides, by means of which the structure on the RF ASIC can be used as a transformer by using the connectors on opposing short sides of one of the first and second conductors as input ports to the transformer, and the connectors on the opposing short sides of the other of the first and second conductors as output ports to the transformer, thereby utilizing an inductive coupling between the conductors.

Suitably, the RF ASIC is a so called Monolithic Microwave Integrated Circuit, an MMIC.

In one embodiment of the RF ASIC of the invention, the first and the second conductors and the isolating material between them together constitute the Metal Insulator Metal, MIM, layers of the MMIC.

### BRIEF DESCRIPTION OF THE DRAWINGS

The invention will be described in more detail in the following, with reference to the appended drawings, in which

FIG. 1 shows a schematic view of a first embodiment of the invention, and

FIG. 2 shows a performance diagram of a transformer of the invention, and

FIG. 3 shows a lumped element model of the invention, and

FIGS. 4-8 show examples of various applications of the invention.

### DETAILED DESCRIPTION

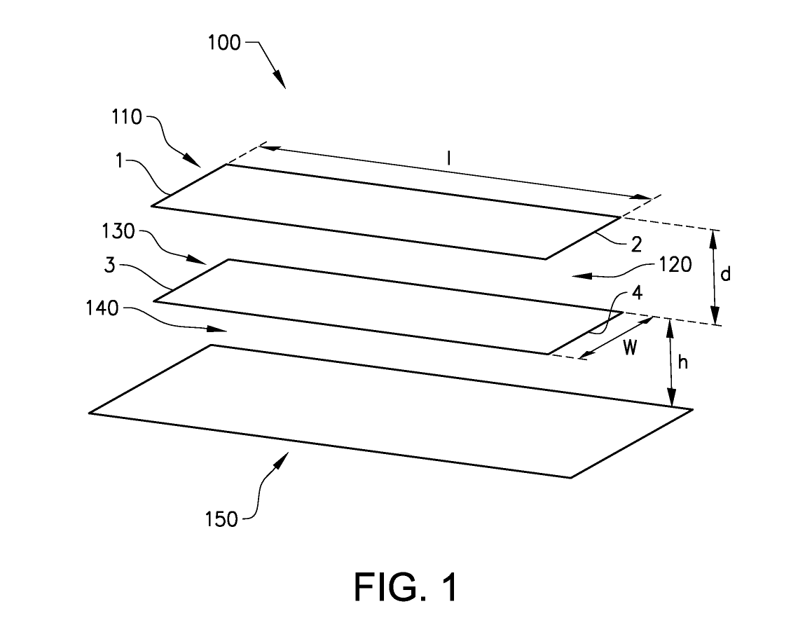

FIG. 1 shows a schematic view of a first embodiment 100 of the invention. The embodiment 100 is designed as a structure within a so called RF ASIC, a Radio Frequency Application Specific Integrated Circuit, and is suitably a so called Monolithic Microwave Integrated Circuit, an MMIC.

As shown in FIG. 1, the embodiment 100 comprises first 110 and second 130 conductors which are essentially flat and plane and are arranged in parallel to each other. The word “parallel” is here used in the sense that the two conductors 110, 130 are arranged so as to be parallel when the RF ASIC is viewed from the “top” direction of the RF ASIC, i.e. the direction in which the RF ASIC is seen when, for example, the RF ASIC is arranged on a Printed Circuit Board, a PCB, and that PCB is viewed from the top direction.

The conductors 110, 130 are arranged at a distance “d” from each other, with the distance “d” being filled by a dielectric material, such as for example air, polyimide, silicon nitride, tantalum oxide or any other material used in MIM capacitors

With the design shown in FIG. 1 and described above, the first 110 and second 130 conductors and the isolating material 120 between them together constitute the Metal Insulator Metal, MIM, layers of the MMIC.

In addition, the conductors 110, 130 exhibit a length L and a width W which are such that the length L exceeds the width W, thus giving the conductors a rectangular shape. The length L and width W are design parameters which can be varied within the scope of the invention. However, a suitable interval for the length, L, is in the range of 500-5000 μm, and a suitable interval for the width W is 10-100 μm. A suitable example of a range for the thickness of the conductors is 0.2-6 μm

Thus, each of the conductors 110, 130 has opposing short sides and opposing long sides, and each of the conductors is equipped with a connector 1, 2, 3, 4 at each of its short sides, so that described structure in the ASIC 100 can be used as a transformer with a 1:1 voltage transformation ratio by using the connectors 1, 2 on one of the opposing short sides of the conductors as input ports to the transformer, and the connectors 3, 4 on the other of the opposing short sides of the conductors as output ports to the transformer, thereby utilizing the inductive coupling between the conductors 110, 130. Naturally, the transformer is reciprocal, so that the two ports on either side can be used as input ports, with the two ports on the other side being used as output ports.

Suitably but not necessarily, the two conductors 110, 130 are of the same width and length. Suitably, the length L of at least one of the conductors is in the range of 500-5000 μm, and the width W of at least one of the conductors is in the range of 10-100 μm.

In one embodiment, the transformer structure 100 in the ASIC also comprises a ground plane 150 at a distance h from the conductor 130 which is the closest to the ground plane 150. The distance h is typically 100 μm, with a suitable range being 50-400 μm. The distance h should suitably be significantly much larger than the distance d between the conductors, for example 100 times larger.

Suitably, the thickness d of the isolating material 120 between the conductors 110, 130 is in the range of 0.1-0.6 μm.

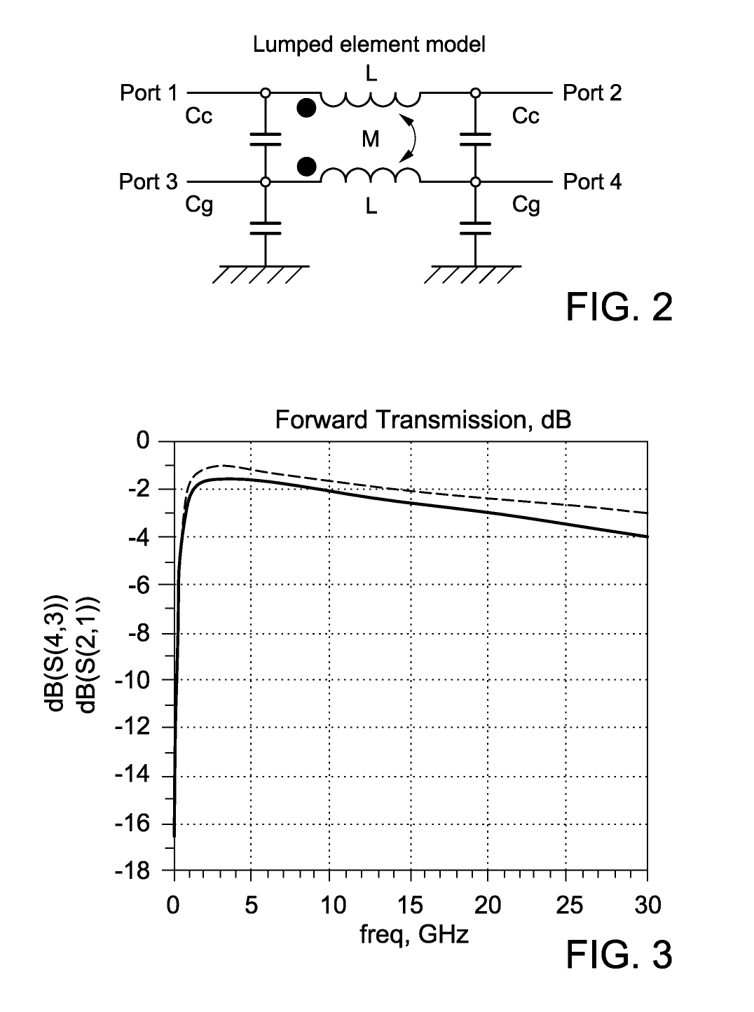

FIG. 2 shows a so called “lumped element model” of the transformer 100 of the invention. FIG. 2 uses the “dot convention” to show the inductive coupling between the two conductors 110, 130, and a capacitive coupling between the two conductors 110, 130 is shown symbolically by means of capacitors Cc. Capacitors Cg are used to symbolically show a capacitive coupling between the lower conductor 130 and the ground plane 150.

Also shown in FIG. 2 are the input/output ports 1, 2, 3, 4 of the transformer 100.

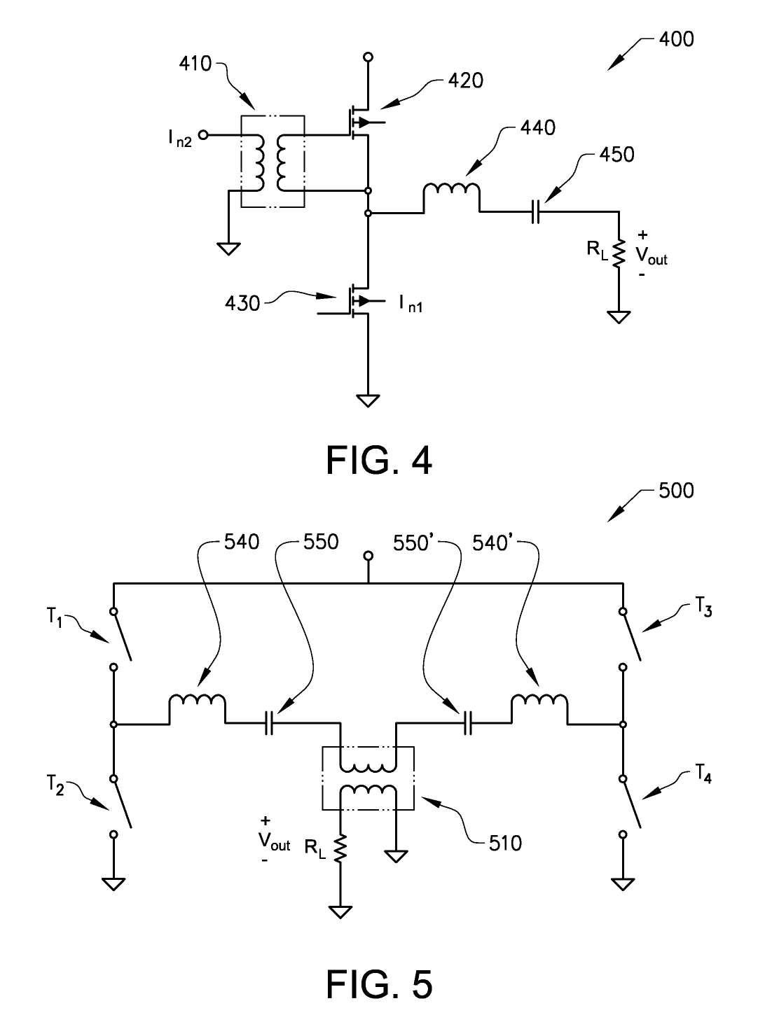

FIG. 3 shows a diagram of the insertion loss of the transformer 100 on a decibel (dB) scale, as a function of the operational frequency in GHz, when the transformer is loaded with input and output impedances of 2 Ω each. As can be seen, the diagram of FIG. 3 shows that the transformer of the invention has a very large band-width potential.

The low-end cut-off frequency is decided by the length of the conductors, i.e. the effective inductance. Insertion loss increases with frequency, due to skin-effect loss in the conductors and decreased capacitive reactance between the input and output conductors, as well as between the conductors and ground.

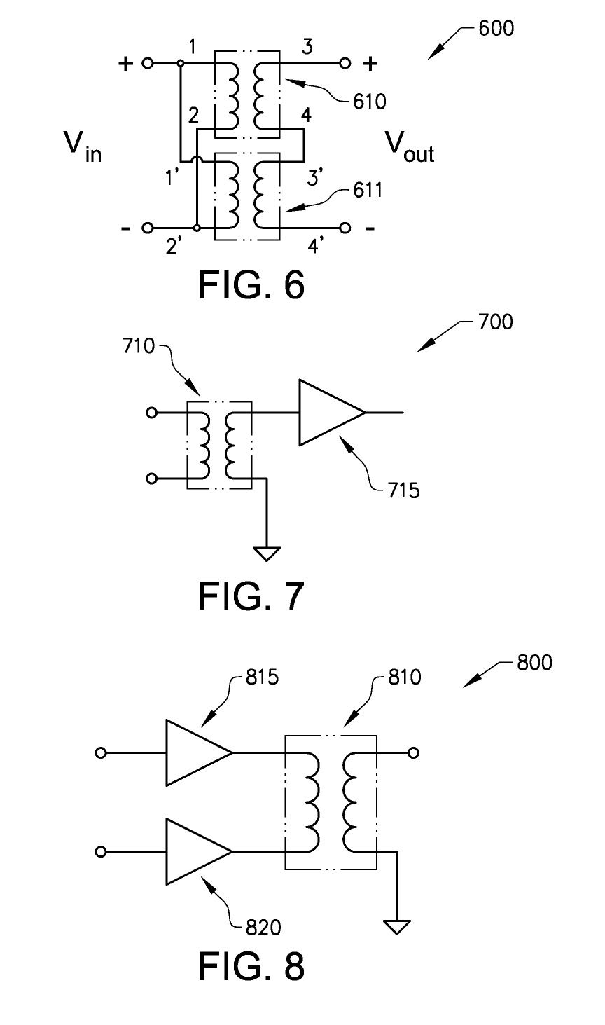

Some applications of a transformer of the invention are shown in FIGS. 4-8. FIG. 4 shows a so called VMCD amplifier, Voltage Mode Class D, 400, which comprises a transformer 410 of the invention. As shown, the VMCD amplifier 400 comprises a first 420 and a second 430 FET transistor which are “stacked” to each other, i.e. connected to each other in the following manner: One port on one of the input/output sides of the transformer 410 is connected to the gate of the transistor 420. The other port on the same side of the transformer 410 is connected to the source of the transistor 420. For example, if the gate of the transistor 420 is connected to the port shown as 3 in FIGS. 1 and 2, the source of the transistor 420 is connected to the port shown as 4 in FIGS. 1 and 2, and the drain of the transistor 430 is connected to the same port of the transformer as the source of the transistor 420.

However, using as an example an embodiment in which ports 3 and 4 are used to connect the stacked transistors 420, 430 as described above, the “other side” of the transformer 410, is connected to ground via port 2. The transformer 410 here acts as a balun, a balanced to unbalanced transformer. As shown, the circuit 400 is connected to a load, symbolically shown as R_{L}, via an inductor 440 in series with a capacitor 450. In the amplifier 400, an input signal should be connected to port 1 as well as to the gate of the transistor 430. The output signal of the amplifier 400 is the voltage over the load R_{L}.

FIG. 5 shows that a transformer of the invention can also be used in a so called VMCD Full Bridge or H-bridge 500. Such a bridge 500 comprises four FET transistors, as opposed to the two FET transistors of the bridge 400 of FIG. 4. The four FET transistors of the amplifier 500 are shown symbolically as four switches T1-T4. As can be seen, T1 and T3, and T2 and T4 respectively, are connected to each other via one of the sides of a transformer 510, i.e. via the pair of ports shown as 1 and 2 or 3 and 4 in FIGS. 1 and 2, while the other side of the transformer 510 connects to ground via one of its ports and is connected to ground via a load shown as R_{L}. As is also shown, T1 and T3, and T2 and T4 respectively, connect to the transformer 510 via respective LC circuits comprising an inductor 540, 540′ in series with a capacitor 550, 550′. The input voltage to the bridge 500 should be connected to the gate of each of the transistors T1-T4, and the output voltage Vₒᵤₜ of the amplifier 500 is the voltage over the load R_{L}. The source of T1 and T3 connect to the drains of T2 and T4, respectively.

FIG. 6 shows that two transformers 610, 611 of the invention can be used to obtain a voltage transformation ratio which is different from that given by one transformer of the invention by connecting the ports of one of the input/output sides of the two transformers to each other in parallel and the ports of the other side to each other in series. As shown in FIG. 6, the ports 1, 1′, 2, 2′, on one side of the transformers 610, 611 are connected to each other in parallel, while the ports 3, 3′, 4, 4′, on the other side of the transformers are connected to each other in series.

Connecting the ports of the input sides in parallel and the ports of the output sides in series doubles the voltage swing at the output and at the same time doubles the input current. The theoretical lossless power transfer is thus 1:1. The transformation ratio (n) of such a transformer is 1:2 and the impedance transformation ratio is 1:4 (n²).

FIG. 7 shows that in one embodiment 700, a transformer 710 of the invention can be used in a circuit to obtain a balanced interface to component such as an amplifier 715. In such an embodiment, the ports on one side of the transformer 710, i.e. ports 1 and 2 or ports 3 and 4, serve as the balanced input ports, and one of the ports on the other side of the transformer 700, serves as the sole input port to the component 715, while “the other port” on the component side connects to ground, for example.

A transformer of the invention can in general also be used as an output transformer, an embodiment 800 of which is shown in FIG. 8. Here, there are two electronic components 815, 820, such as, for example, operational amplifiers, which are connected together at their outputs. In order to obtain an unbalanced output from the circuit 800, the two operational amplifiers are connected to each other via their outputs through one of the sides of an inventive transformer 810, and the other side of the transformer becomes an unbalanced output port of the circuit 800.

The invention is not limited to the examples of embodiments described above and shown in the drawings, but may be freely varied within the scope of the appended claims.

1-9. (canceled)

10. A Radio Frequency Application Specific Integrated Circuit (RF ASIC) comprising:
first and second plane conductors arranged parallel to each other with an isolating material of a certain thickness between them, each one of the first and second plane conductors being rectangular with opposing short sides and opposing long sides;
a ground plane arranged in parallel to said first and second plane conductors and at a certain distance from a nearest one of said first and second plane conductors;
first connectors on the opposing short sides of one of the first and second plane conductors, said first connectors operable as input ports to a transformer formed via inductive coupling between the first and second plane conductors, and corresponding second conductors on the opposing short sides of the other one of said first and second plane conductors, said second connectors operable as output ports form the transformer formed via said inductive coupling between the first and second plane conductors.

11. The RF ASIC of claim 10, wherein the RF ASIC comprises a Monolithic Microwave Integrated Circuit (MMIC).

12. The RF ASIC of claim 11, wherein the first and second plane conductors together with the isolating material comprise the Metal-Insulator-Metal (MIM) layers of the MMIC.

13. The RF ASIC of claim 10, wherein the first and second plane conductors have the same width.

14. The RF ASIC of claim 10, wherein the first and second plane conductors have the same length.

15. The RF ASIC of claim 10, wherein the certain distance of the ground plane from the nearest one of the first and second plane conductors is in the range of 50 μm to 400 μm.

16. The RF ASIC of claim 10, wherein the certain thickness of the isolating material is in the range of 0.1 μm to 0.6 μm.

17. The RF ASIC of claim 10, wherein the length of at least one of the first and second plane conductors is in the range of 500 μm to 5000 μm.

18. The RF ASIC of claim 10, wherein the width of at least one of the first and second plane conductors is in the range of 10 μm to 100 μm.

19. A Radio Frequency Application Specific Circuit (RF ASIC) including a transformer circuit comprising:
a transformer circuit formed within said RF ASIC as first and second plane conductors having an inductive coupling between them and separated by an insulating layer that dielectrically isolates them, each said plane conductor having a rectangular shape defining opposing short sides and opposing long sides;
a ground plane separated from a nearest one of the first and second plane conductors by a defined distance;
first connectors electrically connecting to opposing short sides of the first plane conductor and serving as input ports to said transformer circuit; and
second connectors electrically connecting to opposing short sides of the second plane conductor and serving as output ports of said transformer circuit.

20. The RF ASIC of claim 19, wherein the RF ASIC includes a stacked RF transistor circuit electrically interconnected with said input and output ports of said transformer circuit.
